(19) United States
(12) Patent Application Publication
(10) Pub. No.: US 2025/0207930 A1
(43) Pub. Date: Jun. 26, 2025

(54) METHOD AND SYSTEM FOR DETERMINING A PRIORITY LEVEL OF A ROAD

(71) Applicant: GRABTAXI HOLDINGS PTE. LTD., Singapore (SG)

(72) Inventors: Shanghui Yang, Beijing (CN); Minbo Qiu, Beijing (CN); Chunda Ding, Beijing (CN); Zehua Wang, Beijing (CN); Nicholas William Preston, Singapore (SG)

(21) Appl. No.: 18/958,288

(22) Filed: Nov. 25, 2024

(30) Foreign Application Priority Data
Dec. 22, 2023 (CN) 202311785159.4

(51) Int. Cl. G01C 21/34

(52) U.S. Cl. CPC G01C 21/3492; G01C 21/3461

(57) ABSTRACT

The present disclosure provides methods and systems for determining a priority level of a road. In some examples, there is provided a method comprising: determining, by a processor, a position associated with a road relative to one or more roads based on a total number of one or more vehicles that travelled on the road and a speed of the one or more vehicles on the road; and determining, by the processor, a priority level of the road based on whether a position associated with a priority level relative to one or more priority levels for the one or more roads matches the position associated with the road.

### CROSS REFERENCE

The present invention application is a non-provisional U.S. patent application claiming priority to Chinese patent application serial No. 202311785159.4, which was filed on Dec. 22, 2023, the content of which is incorporated by reference herein in its entirety.

### FIELD OF INVENTION

The present disclosure relates broadly, but not exclusively, to methods and systems for determining a priority level of a road.

### BACKGROUND

Ride-hailing and delivery platforms often face the challenge of determining a priority level of a road. For example, two roads that may be classified as a residential road (e.g., both roads being determined to be of a same priority level) may actually be different in terms of various characteristics such as traffic capacity, accessibility and physical surface.

At present, a conventional method for determining a priority level of a road is using image recognition, in which an image of a road is used to analyse and determine the priority level of the road. However, such a method typically requires resource-intensive processes such as machine learning or artificial intelligence (AI) programs, not to mention the further resources required to obtain and process a large quantity of images of roads. Such usage of resources are further increased for larger areas with more roads.

Further, the conventional method is slow because labelling of sample data and training models for the machine learning and AI programs tend to take a long time to complete. A single machine learning or AI model for performing the conventional method is also unlikely to work for different areas or regions since different models have to be adapted and trained based on conditions specific to each area or region.

A need therefore exists to provide methods and systems that seek to overcome or at least minimize the above mentioned challenges.

### SUMMARY

According to a first aspect of the present disclosure, there is provided a method for determining a priority level of a road, comprising: determining, by a processor, a position associated with a road relative to one or more roads based on a total number of one or more vehicles that travelled on the road and a speed of the one or more vehicles on the road; and determining, by the processor, a priority level of the road based on whether a position associated with a priority level relative to one or more priority levels for the one or more roads matches the position associated with the road.

According to a second aspect of the present disclosure, there is provided a system for determining a priority level of a road, comprising: at least one processor; and at least one memory including computer program code; the at least one memory and the computer program code configured to, with the at least one processor, cause the system at least to: determine a position associated with a road relative to one or more roads based on a total number of one or more vehicles that travelled on the road and a speed of the one or more vehicles on the road; and determine a priority level of the road based on whether a position associated with a priority level relative to one or more priority levels for the one or more roads matches the position associated with the road.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for determining a priority level of a road according to various embodiments of the present disclosure.

FIG. 2 is a schematic diagram of a determination server, according to various embodiments of the present disclosure.

FIG. 3A depicts an exemplary illustration of how roads may be ambiguously classified according to conventional methods.

FIG. 3B depicts an exemplary illustration of how route planning may be affected by ambiguously classified roads.

FIG. 4A depicts an exemplary illustration of a road network comprising roads with and without priority levels according to various embodiments of the present disclosure.

FIG. 4B depicts an exemplary illustration of a road usage distribution based on a Gaussian distribution according to various embodiments of the present disclosure.

FIG. 4C depicts an exemplary graph depicting a relationship of road length to value for a plurality of roads in Ho Chi Minh city according to various embodiments of the present disclosure.

FIG. 4D depicts an exemplary illustration of a python code for sorting roads by value and determining a priority level for each road based on the value according to various embodiments of the present disclosure.

FIG. 4E depicts an exemplary illustration of a road network before and after a priority level for each road in the road network is determined according to various embodiments of the present disclosure.

FIG. 5 illustrates an example flow diagram for determining a priority level of a road according to various embodiments.

FIG. 6 is a schematic block diagram of a general purpose computer system upon which the determination server of FIG. 2 can be practiced.

FIG. 7 is a schematic block diagram of a general purpose computer system upon which a combined transaction processing and determination server of FIG. 1 can be practiced.

FIG. 8 shows an example of a computing device to realize the transaction processing server shown in FIG. 1.

FIG. 9 shows an example of a computing device to realize the determination server shown in FIG. 1.

FIG. 10 shows an example of a computing device to realize a combined transaction processing and determination server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (e.g., associated with a requestor of a product or service) and a provider device (e.g., associated with a provider of the product or service). For example, a platform may offer a service offered by a provider such as a ride, delivery, online shopping, insurance, and other similar services to a requestor. A requestor can typically access the platform via a website, an application, or other similar methods using the requestor device. The provider device may be associated with a provider who may provide a ride or delivery that is requested by a requestor. For example, a request from a requestor device may be a request for a driver to provide a ride, a delivery service or other services such as cleaning, repair, plumbing, renovation, medical emergency, and other similar services. In the present disclosure, the requestor device and the provider device may be referred to herein as a user device, wherein a user associated with the user device may be a requestor or a provider.

A road refers to a stretch of surface built for an entity such as a person, a vehicle or other similar entity to travel along, for example to reach a location. Each road in an area may have different characteristics from one another such as width, length, a total number of vehicles using each road, average speed of vehicles on each road, traffic capacity, accessibility, road surface and other characteristics. An area may comprise one or more roads and may collectively be referred to as a road network of the area.

A position associated with a road relative to one or more roads, for example in a road network, refers to how a road may be ranked in comparison with the one or more roads. The position may be determined based on a total number of one or more vehicles that travelled on the road (e.g., over a specified period of time) and a speed of the one or more vehicles on the road. In an implementation, the total number of vehicles that travelled on the road may be obtained based on global positioning system (GPS) ping data. Such GPS ping data may be obtained directly from a vehicle with GPS capability that are found to be travelling on the road during the specified period of time, or from a provider device or requestor device associated with a user driving the vehicle, or other similar methods. Further, the speed may be calculated by adding up a speed of each vehicle of the one or more vehicles on the road (e.g., dividing a total length travelled by a vehicle on the road with a total amount of time required by the vehicle to traverse the total length) and dividing it by the total number of vehicles that travelled on the road (e.g., over the specified period of time). A value for each road in a road network may be calculated based on these statistics, and the position of each road may be obtained by positioning each road based on these values (e.g., in ascending or descending order). The value associated with a road may be a measure of how accessible the road is, and a higher value may be associated with a higher level of accessibility. In an implementation, the GPS pings for a road and a speed of one or more vehicles on the road may be obtained from map applications such as OpenStreetMap (OSM), Google® map, or other similar applications.

A priority level of a road generally relates to an accessibility level of the road. During route planning, for example for a driver travelling to a location, it is desirable to select roads with a higher priority level to allow a smoother and faster route to the location. Depending on use case application, an appropriate number of priority levels may be configured for a road network. For example, a large geographical area with a dense population and having a large number of roads may be configured to have a larger number of priority levels compared to a smaller geographical area with a lower population and lesser roads. A priority level may be associated with a road length, and therefore a percentage of the road length relative to the total road length in the road network e.g., calculated by (road length)/(total road length)*100. Based on the percentage, the value range associated with each priority level may be determined.

A position associated with a priority level relative to one or more priority levels refers to the value range at which a priority level starts and ends in comparison with the one or more priority levels. A road may be considered to be of a priority level if the value associated with the road falls within the value range of the priority level. In an implementation, a road may be considered to be of a priority level if the value associated with the road falls within the value range of the priority level and the total length of the road is encompassed in the road length associated with the priority level. If the total road length extends beyond the road length associated with the priority level, a next lower priority level may be assigned to the road. For example, assuming three roads of lengths 3 km each has a value that falls within a value range associated with a priority level 1, the priority level 1 being associated with a road length of 8, two of the three roads is encompassed in the associated road length of priority level 1 and is thus assigned the priority level 1. The one remaining road extends beyond the associated road length of priority level 1, and is thus assigned a next lower priority level e.g., priority level 2 assuming that priority level 1 is a higher priority than priority level 2. In an implementation, all the three roads may be assigned the priority level 1 as long as their value is within the value range associated with the priority level 1.

In at least some embodiments, a user may be any suitable type of entity, which may include a person making a request (e.g., a request for a driver), a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing server will be called a registered user. A user who is not registered to the transaction processing server will be called a non-registered user. The term user will be used to collectively refer to both registered and non-registered users. A user may interchangeably be referred to as a requestor (e.g., a person who requests for a product or service) or a provider (e.g., a person who provides the requested product or service to the requestor).

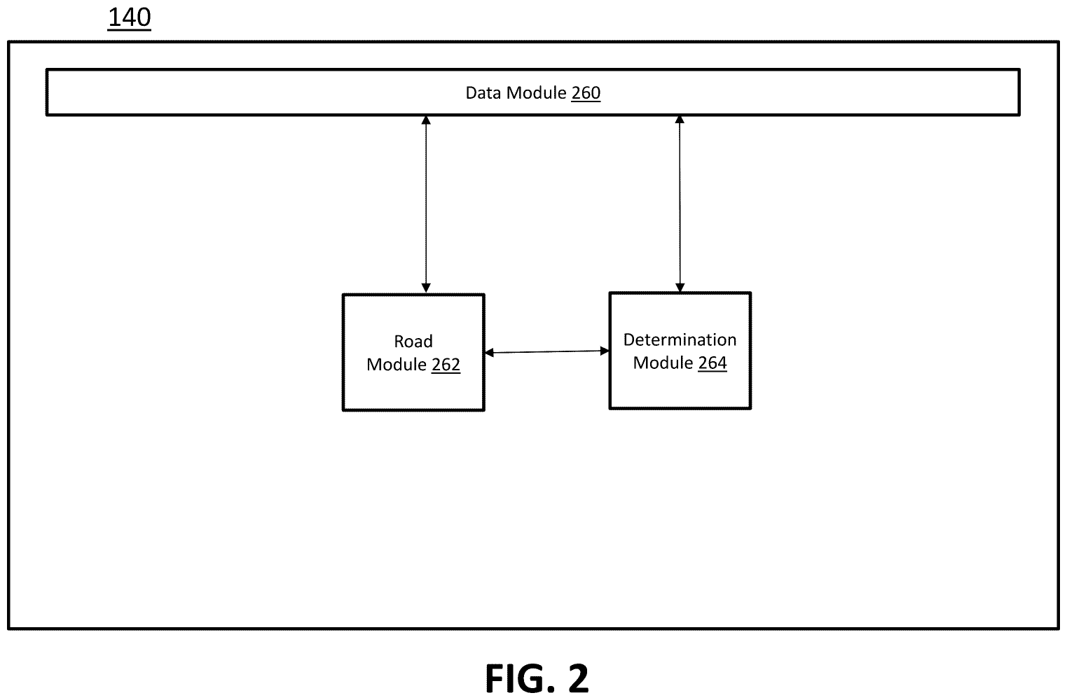

In at least some embodiments, a determination server is a server that hosts software application programs for determining a priority level of a road. The determination server may be implemented as shown in schematic diagram 200 of FIG. 2 for determining a priority level of a road.

In at least some embodiments, a transaction processing server is a server that hosts software application programs for processing payment transactions for, for example, a request for a service, delivery, a travel-coordination request, purchasing of a good or service by a user, and other similar services. The transaction processing server communicates with any other servers (e.g., a determination server) concerning processing payment transactions relating to the purchasing of the good or service, such as a request for a service (which may be referred to as a request, for example for a ride, delivery, or other similar service that requires a provider to locate and arrive at a location as indicated in the request). For example, data relating to a request (e.g., information relating to a location at which a driver is required, date, time, and other similar data) may be provided to the determination server, which may then be processed to determine a driver for the request. The transaction processing server may use a variety of different protocols and procedures in order to process the payment and/or driver requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g., a company or organization) which operates to process transaction requests and/or driver requests e.g., pair a driver to a requestor of the driver request. The transaction processing server may include one or more computing devices that are used for processing transaction requests and/or driver requests.

In at least some embodiments, a transaction account is an account of a user who is registered at a transaction processing server. The user can be a customer, a merchant providing a product for sale on a platform and/or for onboarding the platform, a ride or delivery provider (e.g., a driver), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “identifying”, “detecting”, “recommending”, “determining”, “associating”, “extracting”, “calculating”, “processing”, “storing”, “indicating”, “comparing”, “providing”, “dividing”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In the present disclosure, a system is proposed for determining a priority level of a road, to address the issues of slow processing and inefficient usage of resources. For example, a position associated with a road relative to one or more roads may be determined based on a total number of one or more vehicles that travelled on the road and a speed of the one or more vehicles on the road. A priority level of the road may then be determined based on whether a position associated with a priority level relative to one or more priority levels for the one or more roads matches the position associated with the road. Advantageously, the present solution not only uses less resources and processing power compared to existing methods, it can also be easily implemented on a large scale basis, and can be implemented in different areas without needing to retrain (as opposed to machine learning and/or AI models).

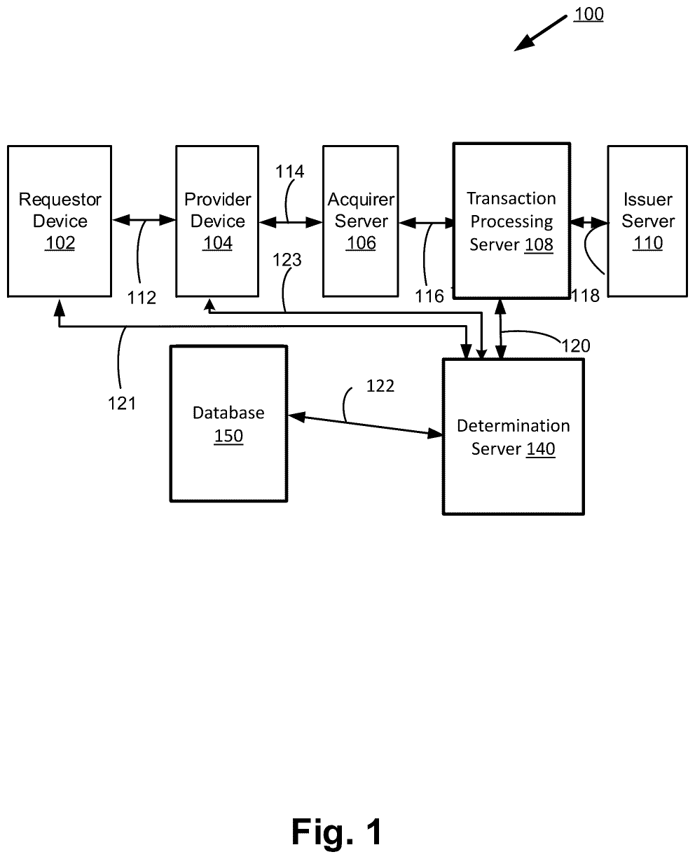

FIG. 1 illustrates a block diagram of an example system 100 for determining a priority level of a road. In some embodiments, the system 100 enables a payment transaction for a good or service, and/or a request e.g., for a ride, or delivery of a physical item (e.g., one or more food items or a parcel) between a requestor (e.g., a user associated with a request) and a provider (e.g., a driver handling the request). A position associated with a road relative to one or more roads may be determined based on a total number of one or more vehicles that travelled on the road and a speed of the one or more vehicles on the road, and a priority level of the road may be determined based on whether a position associated with a priority level relative to one or more priority levels for the one or more roads matches the position associated with the road. A route for the ride or delivery of the physical item from, for example, an original location of the provider (e.g., a location at which the provider is located when accepting a request for the ride or delivery) to a starting location (e.g., a pick-up location indicated in a request for the ride or delivery), and from the starting location to a destination location (e.g., a drop-up location indicated in the request for the ride or delivery) may be determined for the provider by selecting one or more roads based on the priority level associated with each road.

The system 100 comprises a requestor device 102, a provider device 104, an acquirer server 106, a transaction processing server 108, an issuer server 110, a determination server 140 and a database 150.

The requestor device 102 is in communication with a provider device 104 via a connection 112, and may be associated with a user. The connection 112 may be wireless (e.g., via NFC communication, Bluetooth, etc.) or over a network (e.g., the Internet). The requestor device 102 is also in communication with the determination server 140 via a connection 121, wherein the determination server 140 may be configured to receive information relating to a request (e.g., a request for a service such as a delivery or a ride, the information including location information relating to a pick-up location for the service, a destination location for the service, a current location of the requestor device 102, and other similar information) from the requestor device 102. The location information relating to the pick-up location, destination location and current location of the requestor device 102 may comprise an identifier, an address, GPS information, latitudinal and longitudinal coordinates, geohash information, or other similar information associated with the pick-up location, destination location and current location respectively. In an implementation, the location information may be utilized by the determination server 140 for determining a route from the current location to the pick-up location and transmitted to the requestor device 102 and/or provider device 104. The location information may also be utilized by the determination server 140 for determining a route from the pick-up location to the destination location and transmitted to the provider device 104 and/or requestor device 102. The determination server 140 may also be configured to receive GPS ping data from the requestor device 102. In an implementation, the determination server 140 may be configured to utilize the GPS ping data for determining a total number of one or more vehicles that travelled on a road and a speed of the one or more vehicles on the road. The requestor device 102 may be configured to communicate with the provider device 104 (e.g., communication relating to the request with the provider device 104). The connection 121 may be via a network (e.g., the Internet). The requestor device 102 may also be connected to a cloud that facilitates the system 100 for determining a priority level of a road. For example, the requestor device 102 can send a signal or data to the cloud directly via a wireless connection (e.g., via NFC communication, Bluetooth, etc.) or over a network (e.g., the Internet). It will be appreciated that there can be a plurality of requestor devices 102 such that each requestor device 102 is associated with a respective user.

The provider device 104 is in communication with the requestor device 102 as described above, usually via the transaction processing server 108, and may be associated with a provider of a service or delivery (e.g., a provider responding to a request for a service such as, for example, a delivery or a ride to a location). The provider device 104 is, in turn, in communication with an acquirer server 106 via a connection 114. The provider device 104 is also in communication with the determination server 140 via a connection 123, wherein the determination server 140 may be configured to receive information relating to a location of the provider device 104 (e.g., an identifier, an address, GPS information, latitudinal and longitudinal coordinates, geohash information, or other similar information associated with the location), and other similar information from the provider device 104. The location information may be utilized by the determination server 140 for determining a route from the location of the provider device 104 to a pick-up location indicated in a request and transmitted to the provider device 104 and/or requestor device 102. The location information may also be utilized by the determination server 140 for determining a route from the pick-up location to a destination location indicated in the request and transmitted to the provider device 104 and/or requestor device 102. The determination server 140 may also be configured to receive GPS ping data from the provider device 104. In an implementation, the determination server 140 may be configured to utilize the GPS ping data for determining a total number of one or more vehicles that travelled on a road and a speed of the one or more vehicles on the road. When a driver is determined for handling the request, the provider device 104 associated with the driver may be configured to communicate with the requestor device 102 (e.g., communication relating to the request with the requestor device 102). The connections 114 and 123 may be via a network (e.g., the Internet). The provider device 104 may also be connected to a cloud that facilitates the system 100 for determining a priority level of a road. For example, the provider device 104 can send a signal or data to the cloud directly via a wireless connection (e.g., via NFC communication, Bluetooth, etc.) or over a network (e.g., the Internet). It will be appreciated that there can be a plurality of provider devices 104 such that each provider device 104 is associated with a respective user.

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the determination server 140 via a connection 120. The connection 120 may be over a network (e.g., a local area network, a wide area network, the Internet, etc.). In one arrangement, the transaction processing server 108 and the determination server 140 are combined and the connection 120 may be an interconnected bus.

The determination server 140, in turn, is in communication with the database 150 via respective connection 122. The connection 122 may be over a network (e.g., the Internet). The determination server 140 may also be connected to a cloud that facilitates the system 100 for determining a priority level of a road. For example, the determination server 140 can send a signal or data to the cloud directly via a wireless connection (e.g., via NFC communication, Bluetooth, etc.) or over a network (e.g., the Internet).

The database 150 may comprise data that is utilized by the determination server 140 for determining a priority level of a road. For example, data relating to one or more roads in an area, GPS ping data for each road of the one or more roads, a total number of one or more vehicles that travelled on each road for a specified period of time, a speed of the one or more vehicles on each road over the specified period of time, one or more priority levels associated with the one or more roads, and other information and/or data required for determining a priority level of a road may be processed and stored in the database 150. In an implementation, the database 150 may be combined with the determination server 140. In an example, the database 150 may be managed by an external entity.

The determination server 140 may be configured to determine a position associated with a road relative to one or more roads based on a total number of one or more vehicles that travelled on the road and a speed of the one or more vehicles on the road. The determination server 140 may be further configured to determine a priority level of the road based on whether a position associated with a priority level relative to one or more priority levels for the one or more roads matches the position associated with the road. In an implementation, determining the priority level of the road may further comprise determining a percentage of road length associated with the priority level relative to a total road length of the one or more roads, and determining the position associated with the priority level based on the percentage. In an implementation, determining the priority level of the road may further comprise determining whether a total length of the road is encompassed in a road length associated with the priority level. In an implementation, the determination server 140 may assign a next lower priority level to the road when the total length of the road is not encompassed in the road length associated with the priority level.

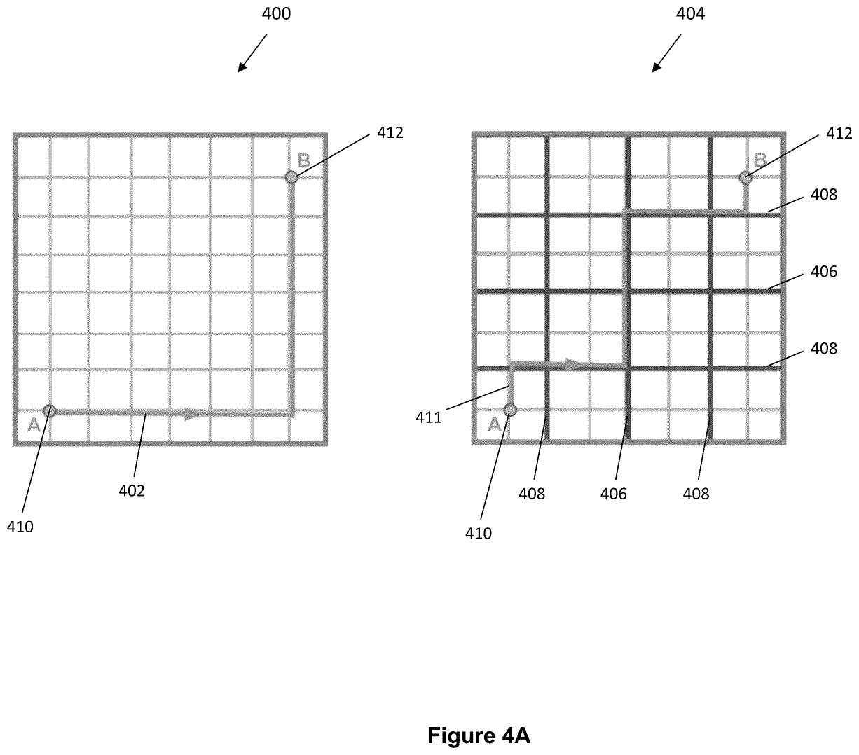

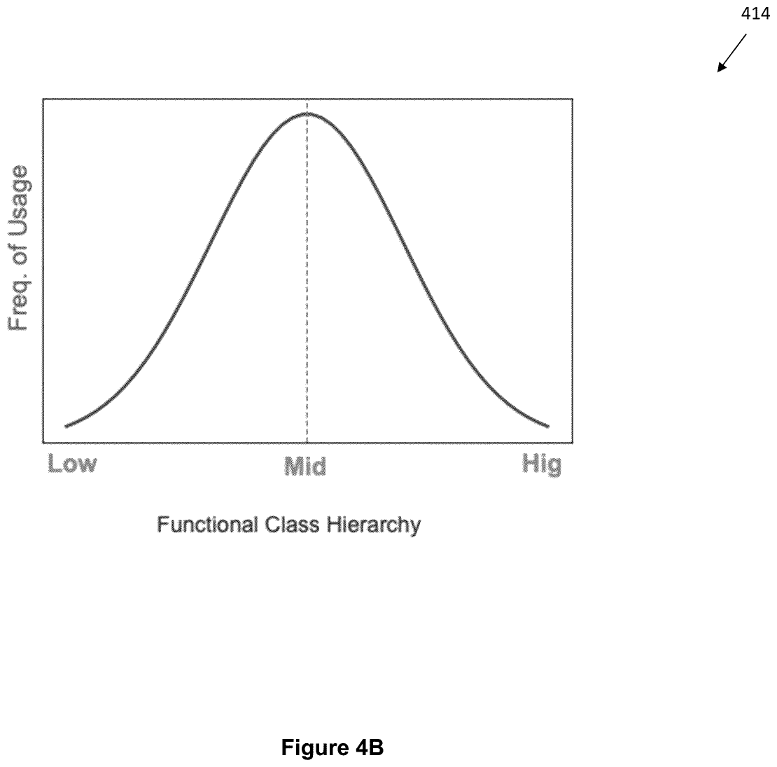

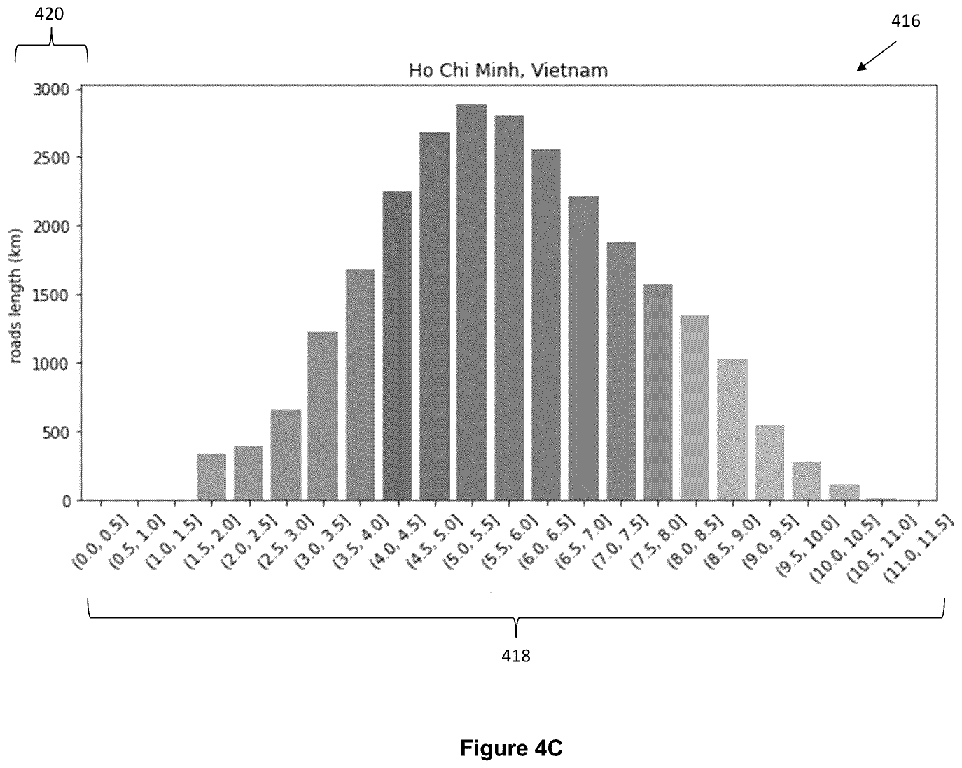

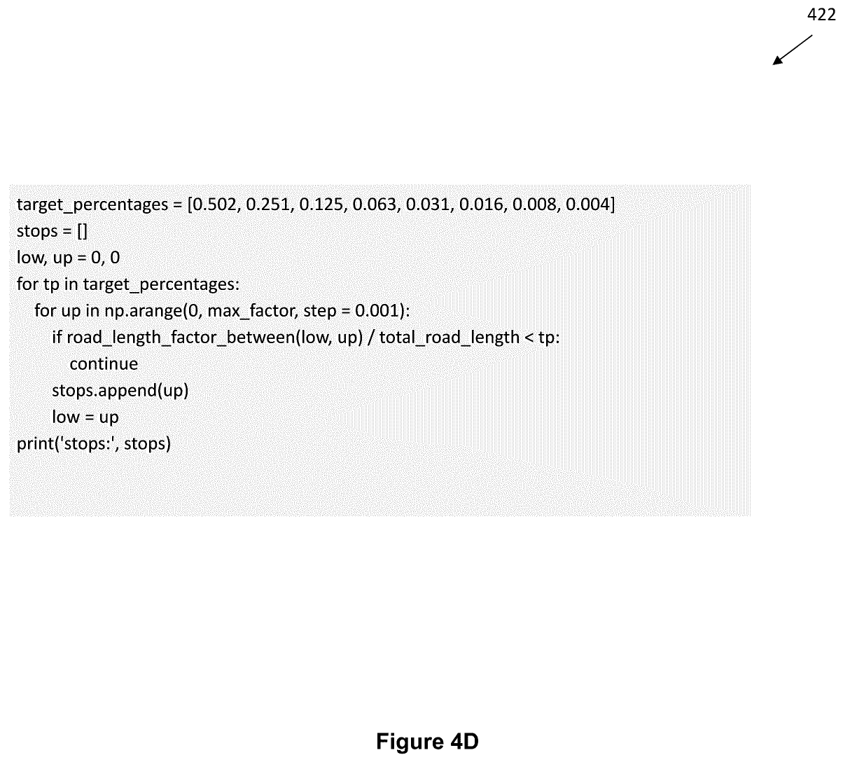

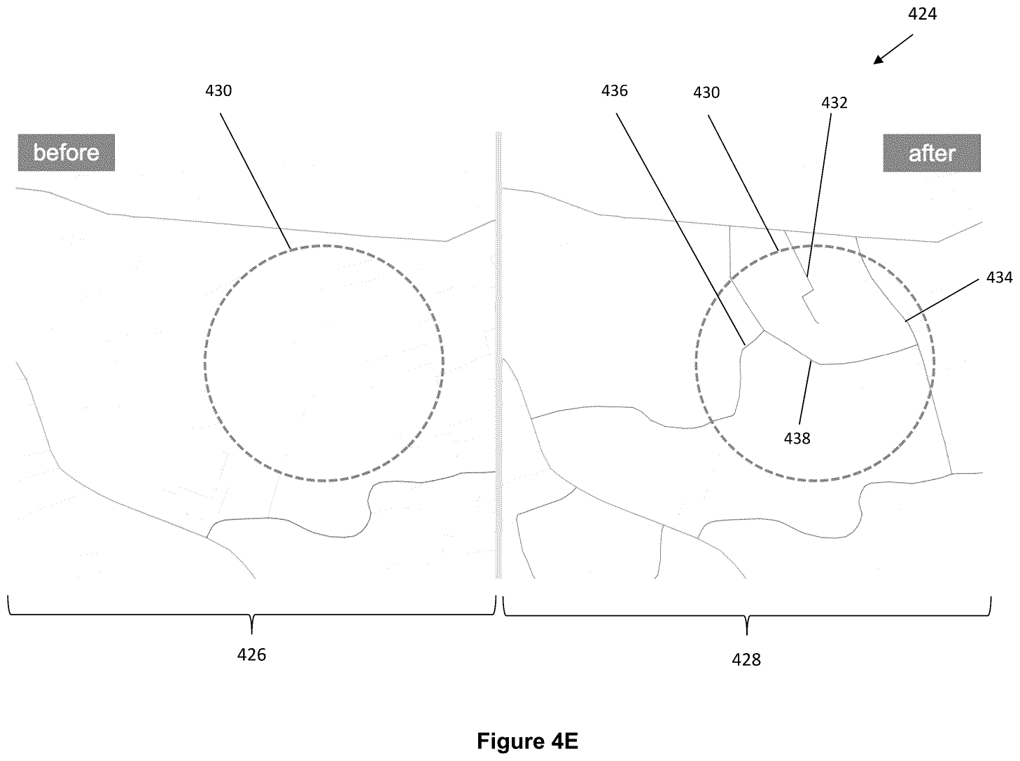

In an implementation, determining the position associated with the road may further comprise calculating, for each road of the one or more roads, a value associated with each road based on a total number of one or more vehicles that travelled on each road and a speed of the one or more vehicles on each road, and positioning each road of the one or more roads based on the value calculated for each road. In an implementation, the determination server 140 may determine whether a value associated with each of two or more roads fall within a same range of values, and combining a total road length of the two or more roads for the same range of values based on the determination. In an implementation, the determination server 140 may assign a priority level to each of the one or more roads based on the value calculated for each road. In an implementation, the determination server 140 may determine the total number of the one or more vehicles that travelled on the road based on a total GPS ping count associated with the road. In an implementation, the determination server 140 may determine the speed of the one or more vehicles on the road based on a movement of a GPS ping associated with each of the one or more vehicles on the road and a total GPS ping count associated with the road. In an implementation, the determination server 140 may, when determining a route from a first location to a second location, select one or more roads based on a priority level associated with each road for the route. This advantageously enables roads of higher priority level to be included during route planning, and therefore enabling a faster travelling time from the first location to the second location. The above implementations are further explained in FIGS. 4A-4E.

In an implementation, there may be more than one databases, in which the determination server 140 may be configured to determine which database to use for each step during the process of determining a priority level of a road. Alternatively, one or more modules may store the above-mentioned data instead of the database 150, wherein the module may be integrated as part of the determination server 140 or external from the determination server 140.

In the illustrative embodiment, each of the devices 102, 104, and the servers 106, 108, 110, 140, and/or database 150 provides an interface to enable communication with other connected devices 102, 104 and/or servers 106, 108, 110, 140, and/or database 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 to send data relating to a request such as information relating to a location at which a driver is required, date, time, and other similar data, and for the provider device 104 to send data relating to a location of an associated provider, in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The determination server 140 is associated with an entity (e.g., a company or organization or moderator of the service). In one arrangement, the determination server 140 is owned and operated by the entity operating the transaction processing server 108. In such an arrangement, the determination server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, in an implementation, there may be functions that are only available to a registered user.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the determination server 140. The user may be a requestor or a provider associated with the requestor device 102 or the provider device 104, respectively.

Details of the registration may include, for example, name of the user, address of the user, emergency contact, blood type or other healthcare information, next-of-kin contact, permissions to retrieve data and information from the requestor device 102 and/or the provider device 104 for determining a priority level of a road, such as permission to retrieve location and status information, and other similar data and information from the requestor device 102 and/or the provider device 104. Alternatively, another device (e.g., a mobile device, a laptop computer, a personal digital assistant computer (PDA), a mobile computer, a tablet computer, or other similar device) may be selected instead of the requestor device 102 and/or the provider device 104 for retrieving the data. Once on-boarded, the user would have a transaction account that stores all the details.

The requestor device 102 is associated with a user (or requestor) who is a party to a transaction that occurs between the requestor device 102 and the provider device 104, or between the requestor device 102 and the determination server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a user who initiates a request for a driver.

The requestor device 102 includes transaction credentials (e.g., a payment account) of a requestor to enable the requestor device 102 to be a party to a payment transaction. If the requestor has a transaction account, the transaction account may also be included (e.g., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a request (e.g., for a delivery, a ride, or other similar service). The user uses the watch or similar wearable to make the request by pressing a button on the watch or wearable.

The provider device 104 is associated with a provider who is also a party to the request (e.g., for a delivery, a ride, or other similar service) that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with a provider of a ride or delivery (e.g., a provider responding to the request).

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a driver, travel co-ordinator or merchant) associated with the provider.

If the provider has a transaction account, the transaction account may also be included (e.g., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make the request by pressing a button on the watch or wearable.

The acquirer server 106 is associated with an acquirer who may be an entity (e.g., a company or organization) which issues (e.g., establishes, manages, administers) a payment account (e.g., a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request or a request for a delivery or other similar service to the transaction processing server 108.

The transaction processing server 108 is configured to process processes relating to a transaction by, for example, forwarding data and information associated with the transaction to the other servers in the system 100 such as the determination server 140. In an example, the transaction processing server 108 may, instead of the requestor device 102 or provider device 104, transmit data relating to a request (e.g., a request for a service such as a delivery or a ride, the data including location information relating to a pick-up location for the service, a destination location for the service, a current location of the requestor device 102 or provider device 104, and other similar information) from the requestor device 102 or provider device 104 to the determination server 140 for determining a route for the requestor device 102 or provider device 104. In an implementation, the transaction processing server 108 may, instead of the requestor device 102 or provider device 104, transmit GPS ping data of the requestor device 102 or provider device 104 to the determination server 140 for determining a total number of one or more vehicles that travelled on a road and a speed of the one or more vehicles on the road. The location information relating to the pick-up location, destination location and current location of the requestor device 102 or provider device 104 may comprise an identifier, an address, GPS information, latitudinal and longitudinal coordinates, geohash information, or other similar information associated with the pick-up location, destination location and current location respectively. The transaction processing server 108 may use a variety of different protocols and procedures in order to process the payment and/or requests. It will be appreciated that payment for a transaction may be made via a variety of methods such as credit cards, debit cards, digital wallets, buy-first pay-later schemes, and other similar payment methods.

The issuer server 110 is associated with an issuer and may include one or more computing devices that are used to perform a payment transaction. The issuer may be an entity (e.g., a company or organization) which issues (e.g., establishes, manages, administers) a transaction credential or a payment account (e.g., a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The database 150 is a database or server associated with an entity (e.g., a company or organization) which manages (e.g., establishes, administers) data relating to users, transactions, products, services, and other similar data, for example relating to the entity. In an arrangement, the database 150 may comprise data that is utilized by the determination server 140 for determining a priority level of a road. For example, data relating to one or more roads in an area, GPS ping data for each road of the one or more roads, a total number of one or more vehicles that travelled on each road for a specified period of time, a speed of the one or more vehicles on each road over the specified period of time, one or more priority levels associated with the one or more roads, and other information and/or data required for determining a priority level of a road may be processed and stored in the database 150. In an implementation, the database 150 may be combined with the determination server 140. In an example, the database 150 may be managed by an external entity.

Advantageously, the system 100 only uses less resources and processing power compared to existing methods for determining a priority level for a road, it can also be easily implemented on a large scale basis, and can be implemented in different areas without needing to retrain (as opposed to machine learning and/or AI models).

FIG. 2 illustrates a schematic diagram of an example determination server 140 according to various embodiments. The determination server 140 may comprise a data module 260 configured to receive data and information from the requestor device 102, provider device 104, transaction processing server 108, database 150, a cloud and other sources of information to determine a driver for a request by the determination server 140. For example, the data module 260 may be configured to receive data and information required for: a position associated with a road relative to one or more roads based on a total number of one or more vehicles that travelled on the road and a speed of the one or more vehicles on the road; determining a priority level of the road based on whether a position associated with a priority level relative to one or more priority levels for the one or more roads matches the position associated with the road; determining a percentage of road length associated with the priority level relative to a total road length of the one or more roads, and determining the position associated with the priority level based on the percentage; determining whether a total length of the road is encompassed in a road length associated with the priority level; assigning a next lower priority level to the road when the total length of the road is not encompassed in the road length associated with the priority level; calculating, for each road of the one or more roads, a value associated with each road based on a total number of one or more vehicles that travelled on each road and a speed of the one or more vehicles on each road, and positioning each road of the one or more roads based on the value calculated for each road; determining whether a value associated with each of two or more roads fall within a same range of values, and combining a total road length of the two or more roads for the same range of values based on the determination; assigning a priority level to each of the one or more roads based on the value calculated for each road; determining the total number of the one or more vehicles that travelled on the road based on a total GPS ping count associated with the road; determining the speed of the one or more vehicles on the road based on a movement of a GPS ping associated with each of the one or more vehicles on the road and a total GPS ping count associated with the road; when determining a route from a first location to a second location, selecting one or more roads based on a priority level associated with each road for the route; and other similar processes from the requestor device 102, the provider device 104, transaction processing server 108, database 150, and/or other sources of information. The data module 260 may be further configured to send information relating to data retrieved in response to a request to the requestor device 102, the provider device 104, the transaction processing server 108, or other destinations where the information is required.

The determination server 140 may comprise a road module 262 that is configured for determining a position associated with a road relative to one or more roads based on a total number of one or more vehicles that travelled on the road and a speed of the one or more vehicles on the road. In an implementation, the road module 262 may be configured to calculate, for each road of the one or more roads, a value associated with each road based on a total number of one or more vehicles that travelled on each road and a speed of the one or more vehicles on each road, and position each road of the one or more roads based on the value calculated for each road. In an implementation, the road module 262 may be configured to determine whether a value associated with each of two or more roads fall within a same range of values, and combining a total road length of the two or more roads for the same range of values based on the determination. In an implementation, the road module 262 may be configured to determine the total number of the one or more vehicles that travelled on the road based on a total GPS ping count associated with the road. In an implementation, the road module 262 may be configured to determine the speed of the one or more vehicles on the road based on a movement of a GPS ping associated with each of the one or more vehicles on the road and a total GPS ping count associated with the road. The above process is further explained in FIGS. 4A-4E.

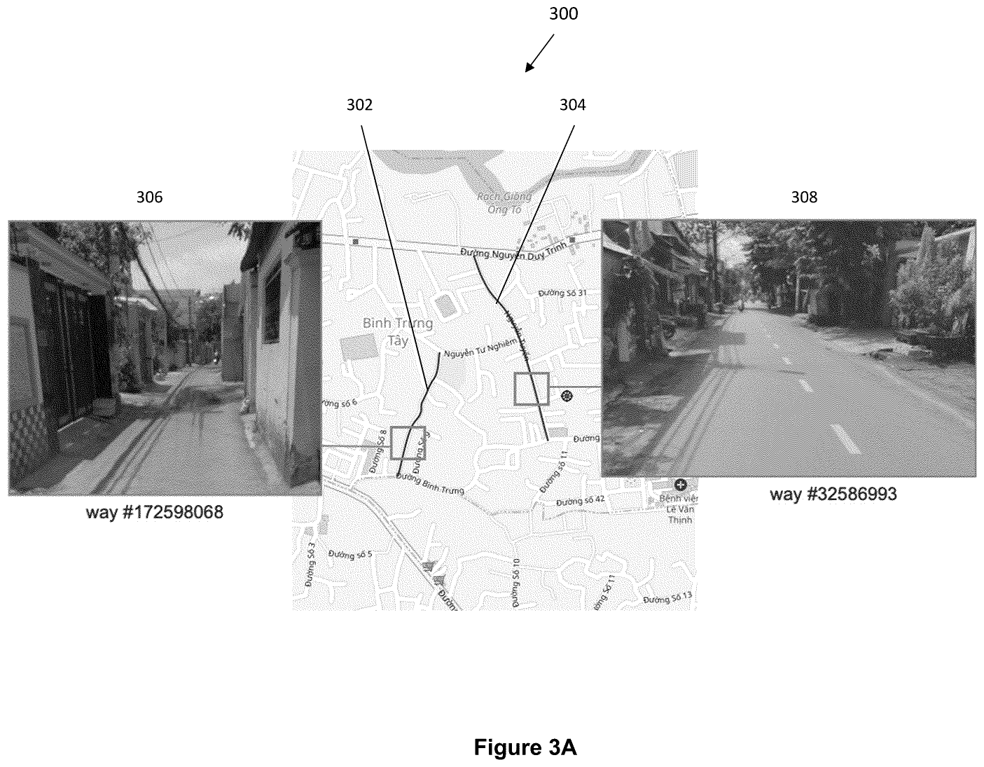

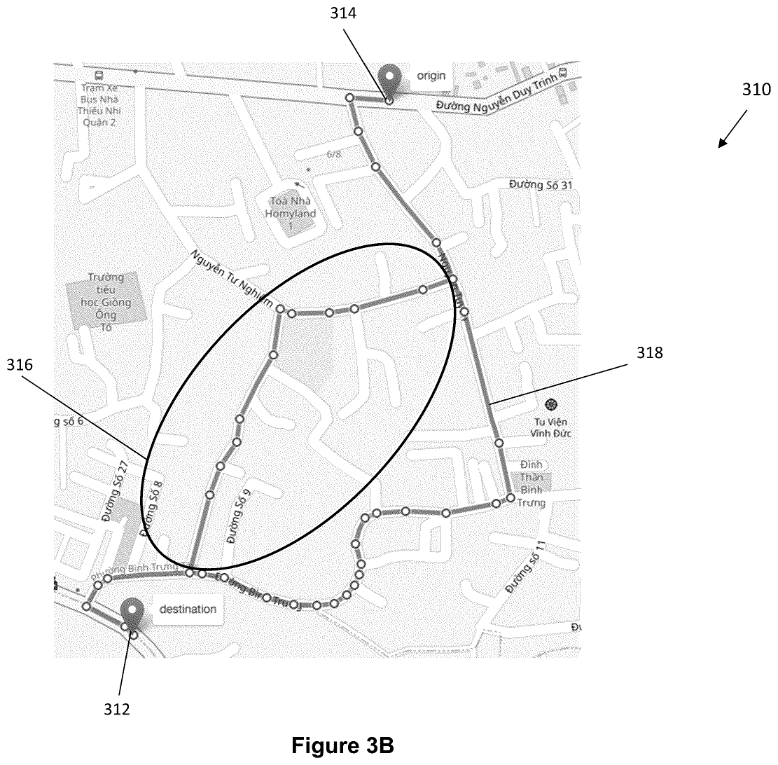

The determination server 140 may also comprise a determination module 264 that is configured for determining a priority level of the road based on whether a position associated with a priority level relative to one or more priority levels for the one or more roads matches the position associated with the road (e.g., determined by the road module 262). In an implementation, the determination module 264 may be configured to determine a percentage of road length associated with the priority level relative to a total road length of the one or more roads, and determining the position associated with the priority level based on the percentage. In an implementation, the determination module 264 may be configured to determine whether a total length of the road is encompassed in a road length associated with the priority level. In an implementation, the determination module 264 may be configured to assign a next lower priority level to the road when the total length of the road is not encompassed in the road length associated with the priority level. In an implementation, the determination module 264 may be configured to assign a priority level to each of the one or more roads based on the value calculated for each road. In an implementation, the determination module 264 may, when determining a route from a first location to a second location, select one or more roads based on a priority level associated with each road for the route. This advantageously enables roads of higher priority level to be included during route planning, and therefore enabling a faster travelling time from the first location to the second location. The above process is further explained in FIGS. 3 and 4A-4E.

Each of the data module 260, road module 262 and determination module 264 may further be in communication with a processing module (not shown) of the determination server 140, for example for coordination of respective tasks and functions during the process. The data module 260 may be further configured to communicate with and store data and information for each of the processing module, road module 262 and determination module 264. Alternatively, all the tasks and functions required for adaptively determining a priority level of a road may be performed by a single processor of the determination server 140.

FIG. 3 depicts an exemplary illustration of how roads may be ambiguously classified according to conventional methods. For example, in a map 300 that may be featured in a data map application such as OSM, two roads 302 and 304 may both be classified as residential roads. However, as can be seen from image 306 showing a cross section of road 302 and image 308 showing a cross section of road 304, both roads look very different in terms of traffic capacity, accessibility and physical surface. Thus, roads 302 and 304 being of a same classification is ambiguous and is unable to serve as an accurate indication of whether a road should be selected during route planning.

For example, referring to illustration 310 depicting a route planning from a location 312 to a location 314, road 316 may be selected for the route because it is shorter in length than road 318. This may occur if each road in the map does not have a priority hierarchy (e.g., each road has the same priority level as one another), or if each road is ambiguously classified as shown in illustration 300. However, it may be the case that road 316 is actually of a worse traffic capacity (e.g., cars may tend to move very slowly on road 316 due to traffic conditions, road conditions or other similar issues) than road 318 (e.g., road 316 should have a lower priority level than road 318) and selecting road 316 instead of road 318 for the route planning between location 312 and 314 would likely result in an inefficient and slower route.

Thus, in the presently proposed solution, it is possible to determine a priority level of a road, allowing for an improved route planning in which roads of a higher priority level are prioritized. Further, the present solution not only uses less resources and processing power compared to existing methods, it can also be easily implemented on a large scale basis, and can be implemented in different areas without needing to retrain (as opposed to machine learning and/or AI models).

A road network without any priority level would look like illustration 400 of FIG. 4A. All roads in this network have the same priority level. A route planning system built on this road network would suggest a shortest route from location 410 to location 412 such as route 402. In most scenarios, this route is inefficient because it does not take into account an accessible level of each road selected for the route. On the other hand, illustration 404 of FIG. 4A shows a road network with three priority levels e.g., roads 406 with priority level 1 (e.g., a highest priority level indicative of roads having a highest accessibility), roads 408 with priority level 2, and the remaining roads with priority level 3 (e.g., lowest priority level indicative of roads having a lowest accessibility). The route 411 from location 410 to location 412 thus changes significantly to select roads 406 (having the highest priority level) as much as possible. It is advantageously a more efficient route based on travel time considerations.

Generally, a road network model with an ideal priority hierarchy should look like illustration 404 (e.g., priority level 2 associated with twice the road length associated with priority level 1, priority level 3 associated with twice the road length associated with priority level 2, and so on). From this model, it is possible to derive a formula about road length relation between each priority level (e.g., n priority levels being L₁, L₂, L₃, . . . to Lₙ), for example as follows: L₁:L₂:L₃: . . . :Lₙ=1:2:4:8: . . . :2ⁿ⁻¹. It will be appreciated that a suitable number of priority levels may be determined based on use case application and one or more characteristics of the concerned area (e.g., size of the area, number of roads in the area, population density of the area, and other similar characteristics).

A general rule for road usage is that roads associated with priority levels in the middle range (e.g., roads 408 with priority level 2 in illustration 404) are typically the busiest (e.g., having the highest frequency of road use and thus a highest total GPS ping count range). Thus, a graph plotted based on frequency of road usage to priority level of each road in a road network may be a Gaussian distribution graph 414 as shown in FIG. 4B. For the present solution, the formula L₁:L₂:L₃: . . . :Lₙ=1:2:4:8: . . . :2ⁿ⁻¹ may be used for determining a position of each priority level relative to one or more priority levels (depending on a total number of priority levels that may be determined for a road network) based on a percentage of road length associated with each priority level relative to a total road length of the one or more roads in the road network. For example, the percentage of road length for each priority level (assuming there are 8 priority levels) may be calculated according to Table 1 as shown below.

TABLE 1

| Priority Level | Ratio | % of Road Length |
|---|---|---|
| L1 (highest) | 1 | 1/255 = 0.39% |
| L2 | 2 | 2/255 = 0.78% |
| L3 | 4 | 4/255 = 1.57% |
| L4 | 8 | 8/255 = 3.14% |
| L5 | 16 | 16/255 = 6.27% |
| L6 | 32 | 32/255 = 12.55% |
| L7 | 64 | 64/255 = 25.10% |
| L8 (lowest) | 128 | 128/255 = 50.20% |
| sum | 255 | 100.0% |

For example, priority level 1 may have a road length percentage of 0.39%, priority level 2 may have a road length percentage of 0.78%, and so on.

Further, a total number of one or more vehicles that travelled on a road may be identified based on, for example, GPS ping data associated with the road. The GPS ping data may be obtained from various sources such as a vehicle with GPS capability that is found to be travelling on the road during the specified period of time, the requestor device 102 (e.g., if a user associated with the requestor device 102 is travelling along the road), the provider device 104 (e.g., if a user associated with the provider device 104 is travelling along the road), or other similar sources. A speed of the one or more vehicles on the road may also be calculated. For example, the speed may be calculated by adding up a speed of each vehicle of the one or more vehicles on the road (e.g., dividing a total length travelled by a vehicle on the road with a total amount of time required by the vehicle to traverse the total length) and dividing it by the total number of vehicles that travelled on the road (e.g., over the specified period of time). In an implementation, the speed of the one or more vehicles may be an average speed of the one or more vehicles on the road during a specified period of time. The GPS ping data and speed of the one or more vehicles may also be obtained from map applications such as OSM, Google® map, or other similar applications. An example of a dataset for each road and a corresponding GPS ping count and average speed of vehicles that may be obtained from a map application is shown in Table 2 below.

TABLE 2

| Road | | Average speed |
|---|---|---|
| identifier | GPS ping count | (km/h) |
| 172598068 | 1,355 | 15.32 |
| 32586993 | 16,758 | 24.49 |
| . . . | . . . | . . . |

Based on the total number of vehicles on the road and speed of the one or more vehicles on the road that are obtained for the road, it is possible to calculate a value associated with the road that may be a measure of how accessible the road is. A higher value may be associated with a higher level of accessibility, and may be calculated using a formula: Value=\sqrt{log(pings_count)×log(avg_speed)}. Based on a road length distribution of the value calculated for several cities such as Manila, Ho Chi Minh, Jakarta, Bangkok, Chiang Mai and Cebu in Southeast Asia, it can be observed that all of them are very close to a Gaussian distribution as shown in graph 416 in FIG. 4C. Graph 416 is plotted with values that are calculated for each road in Ho Chi Minh city based on a total number of vehicles that travelled on each road for a specified period of time (e.g., based on a total GPS ping count for the specified period of time) and an average speed of the vehicles on the road during the specified period of time using the formula Value=\sqrt{log(pings_count)×log(avg_speed)}. Each entry in the graph 416 is a total road length (Y-axis) plotted against a value range (X-axis). For example, a road with a value of 8.1 is plotted within the value range 8.0-8.5 in the graph 416. If this is the only road that falls within the 8.0-8.5 value range, the Y-axis for this 8.0-8.5 value range is the total length of the road. Thus, each road may be positioned relative to the one or more roads based on the value calculated for each road. In an implementation, if there are more than one roads that fall within the 8.0-8.5 value range, the Y-axis for this 8.0-8.5 value range is a combined total length of the more than one roads. The resultant graph 416 indicates that the value is advantageously a strong signal for classifying each road, and it can directly and easily be applied to different cities.

Assuming that the formula L₁:L₂:L₃: . . . :Lₙ=1:2:4:8: . . . :2ⁿ⁻¹ is used with 8 priority levels for the one or more roads of Ho Chi Minh city, the percentages that are calculated for each priority level in Table 2 may be used to calculate a value range associated with each priority level, for example as shown in Table 3:

TABLE 3

| Priority | |
|---|---|
| Level | Value Range |
| L1 | >10.212 |
| L2 | (9.707, 10.212] |
| L3 | (9.242, 9.707] |
| L4 | (8.747, 9.242] |
| L5 | (8.138, 8.747] |
| L6 | (7.197, 8.138] |
| L7 | (5.906, 7.197] |
| L8 | <=5.906 |

For example, priority level 1 may be associated with a value range of >10.212, priority level 2 may be associated with a value range of 9.707 to 10.212, priority level 3 may be associated with a value range of 9.242 to 9.707, and so on. Thus, the position of each priority level may be determined based on the percentage associated with each priority level. A priority level may then be assigned to each of the one or more roads in Ho Chi Minh city based on the value calculated for each road. For example, a road having a value of 9 may be assigned a priority level 3 (e.g., with a value range of 9.242 to 9.707). Further, it may be determined whether a total length of the road is encompassed in the road length associated with the priority level before the priority level can be assigned to the road. For example, assuming that the road associated with the value 9 has a road length of 1 km and is the only road within the value range 9.242 to 9.707, and that the priority level 3 is associated with a road length of 3 km, the road may be considered as encompassed in the road length associated with priority level 3 and thus be assigned with priority level 3. If more than one roads are within the value range 9.242 to 9.707, a next lower priority level (e.g., priority level 4) may be assigned to the road(s) whose road lengths are not encompassed in the road length associated with priority level 3. In an implementation, each of the more than one roads may be assigned the priority level 3 as long as their associated value is within the value range 9.242 to 9.707.

The above processes may be implemented via a program, for example a Python code as shown in illustration 422 of FIG. 422. The target percentages in line 423 is based on the percentages calculated as shown in Table 1 for each priority level, and is utilized in the program as cut off values for each priority level. In this program, the one or more roads in Ho Chi Minh city are sorted according to each of their corresponding value (e.g., in ascending order from a smallest value to a largest value, or vice versa). Roads starting from those having the highest value are assigned priority level 1 until a next road has a value that does not fall within the value range associated with priority level 1 (e.g., >10.212) and/or a total length of a next road is not encompassed in a total road length associated with priority level 1. The next road is then assigned a next lower priority level (e.g., priority level 2) and the process continues until all roads are assigned a priority level. It will be appreciated that other programming languages may also be utilized for the implementation.

FIG. 4E depicts an exemplary illustration 424 of a road network before and after a priority level for each road in the road network is determined according to various embodiments of the present disclosure. Based on a subset of roads that are within circle 430 in map 426 (e.g., before a priority level for each road is determined), it can be seen that each road is of a same priority level. In contrast, for the same subset of road within circle 430 in map 428 (e.g., after a priority level for each road is determined), it can be seen that roads 432, 434, 436 and 438 are now assigned to be of a higher priority level (e.g., indicated in a darker shade) compared to other roads within the circle 430. These roads will thus be prioritized for purposes of route planning, for example from a first location to a second location.

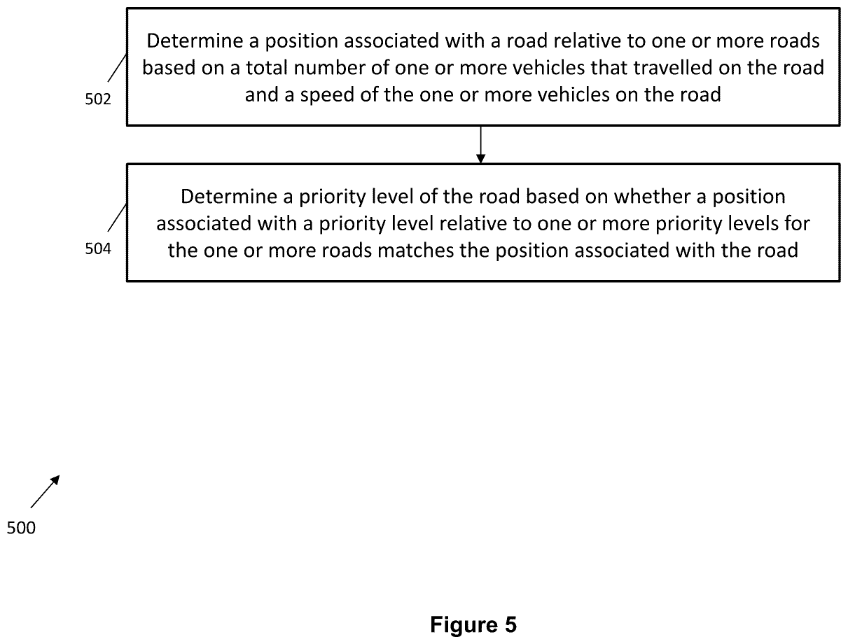

FIG. 5 illustrates an example flow diagram for a method 500 for determining a priority level of a road according to various embodiments. In a step 502, a position associated with a road relative to one or more roads is determined based on a total number of one or more vehicles that travelled on the road and a speed of the one or more vehicles on the road. In a step 504, a priority level of the road is determined based on whether a position associated with a priority level relative to one or more priority levels for the one or more roads matches the position associated with the road.

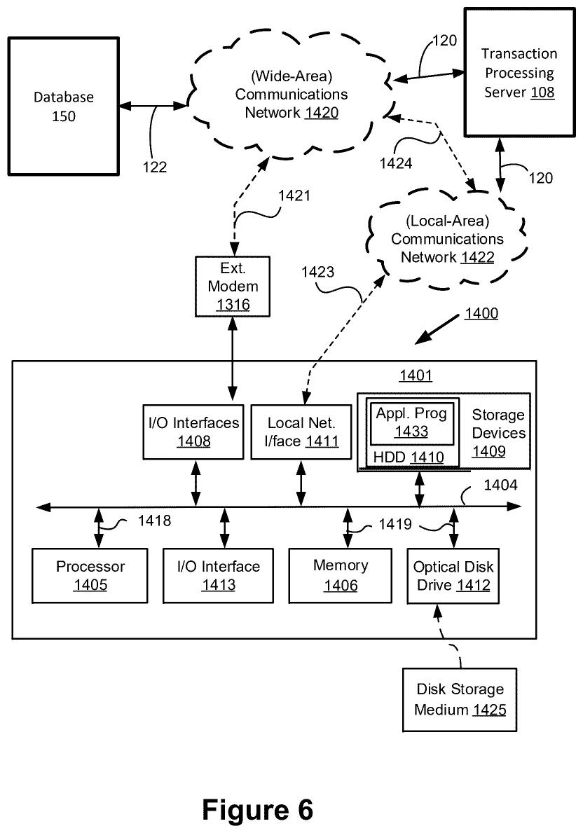

FIG. 6 depict an example computer system 1400, in accordance with which the determination server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 6A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 500, where performed by the determination server 140 may be implemented using the computer system 1400. The processes may be implemented as one or more software application programs 1433 executable within the computer system 1400. In particular, the method 500 is effected by instructions in the software 1433 that are carried out within the computer system 1400. The software instructions may be formed as one or more code modules, each for performing one or more particular tasks. The software may also be divided into two separate parts, in which a first part and the corresponding code modules performs the method 500 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a determination server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a determination server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the determination server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

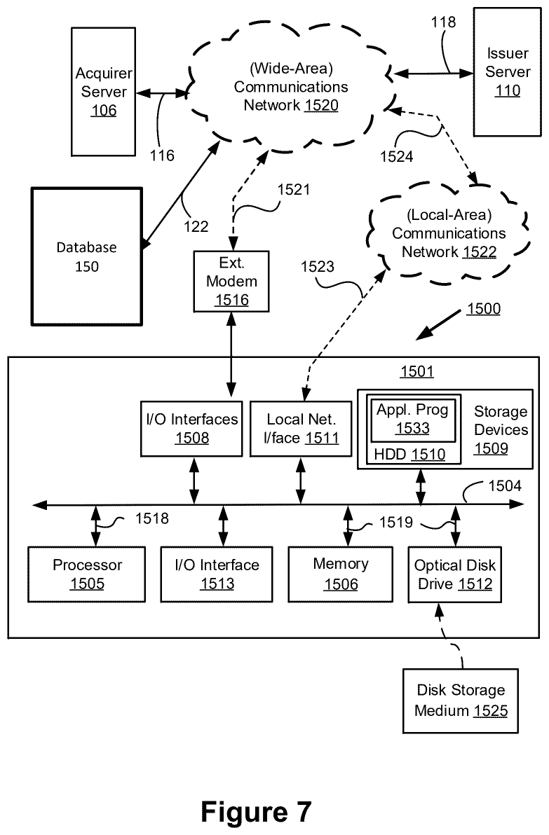

FIG. 7 shows an implementation of the transaction processing server 108 (i.e., the computer system 1300). In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 500. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104, and the acquirer server 106 and the issuer server 110 to respectively receive and transmit a transaction, a request for a service, delivery, a travel-coordination request, purchasing of a good or service by a user, and other similar services. The transaction processing module 806 may be configured to process processes relating to a transaction by, for example, forwarding data and information associated with the transaction to the other servers in the system 100 such as the determination server 140. In an example, the transaction processing module 806 may, instead of the requestor device 102 or provider device 104, transmit data relating to a request (e.g., a request for a service such as a delivery or a ride, the data including location information relating to a pick-up location for the service, a destination location for the service, a current location of the requestor device 102 or provider device 104, and other similar information) from the requestor device 102 or provider device 104 to the determination server 140 for determining a route for the requestor device 102 or provider device 104. In an implementation, transaction processing module 806 may, instead of the requestor device 102 or provider device 104, transmit GPS ping data of the requestor device 102 or provider device 104 to the determination server 140 for determining a total number of one or more vehicles that travelled on a road and a speed of the one or more vehicles on the road. The location information relating to the pick-up location, destination location and current location of the requestor device 102 or provider device 104 may comprise an identifier, an address, GPS information, latitudinal and longitudinal coordinates, geohash information, or other similar information associated with the pick-up location, destination location and current location respectively. The transaction processing module 806 may use a variety of different protocols and procedures in order to process the payment and/or requests. It will be appreciated that payment for a transaction may be made via a variety of methods such as credit cards, debit cards, digital wallets, buy-first pay-later schemes, and other similar payment methods.

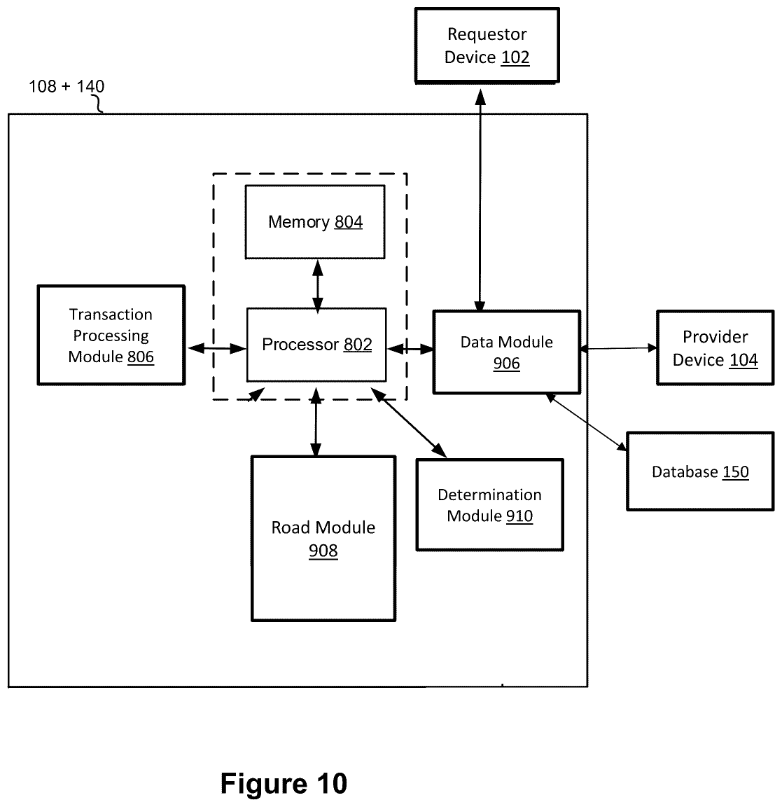

FIG. 10 shows an alternative implementation of the determination server 140 (e.g., the computer system 1400). In the alternative implementation, determination server 140 may be generally described as a physical device comprising at least one processor 902 and at least one memory 904 including computer program codes. The at least one memory 904 and the computer program codes are configured to, with the at least one processor 902, cause the determination server 140 to perform the operations described in the method 500. The determination server 140 may also include a data module 906, a road module 908 and a determination module 910. The memory 904 stores computer program code that the processor 902 compiles to have each of the modules 906 to 910 performs their respective functions.

With reference to FIGS. 1 to 5, the road module 908 performs the function of determining a position associated with a road relative to one or more roads based on a total number of one or more vehicles that travelled on the road and a speed of the one or more vehicles on the road. In an implementation, the road module 908 may be configured to calculate, for each road of the one or more roads, a value associated with each road based on a total number of one or more vehicles that travelled on each road and a speed of the one or more vehicles on each road, and position each road of the one or more roads based on the value calculated for each road. In an implementation, the road module 908 may be configured to determine whether a value associated with each of two or more roads fall within a same range of values, and combining a total road length of the two or more roads for the same range of values based on the determination. In an implementation, the road module 908 may be configured to assign a priority level to each of the one or more roads based on the value calculated for each road. In an implementation, the road module 908 may be configured to determine the total number of the one or more vehicles that travelled on the road based on a total GPS ping count associated with the road. In an implementation, the road module 908 may be configured to determine the speed of the one or more vehicles on the road based on a movement of a GPS ping associated with each of the one or more vehicles on the road and a total GPS ping count associated with the road.

With reference to FIGS. 1 to 5, the determination module 910 performs the function of determining a priority level of the road based on whether a position associated with a priority level relative to one or more priority levels for the one or more roads matches the position associated with the road (e.g., determined by the road module 908). In an implementation, the determination module 910 may be configured to determine a percentage of road length associated with the priority level relative to a total road length of the one or more roads, and determining the position associated with the priority level based on the percentage. In an implementation, the determination module 910 may be configured to determine whether a total length of the road is encompassed in a road length associated with the priority level. In an implementation, the determination module 910 may be configured to assign a next lower priority level to the road when the total length of the road is not encompassed in the road length associated with the priority level. In an implementation, the determination module 910 may be configured to assign a priority level to each of the one or more roads based on the value calculated for each road. In an implementation, the determination module 910 may, when determining a route from a first location to a second location, select one or more roads based on a priority level associated with each road for the route. This advantageously enables roads of higher priority level to be included during route planning, and therefore enabling a faster travelling time from the first location to the second location.

With reference to FIGS. 1 to 5, the data module 906 performs the functions of receiving data and information from the requestor device 102, provider device 104, transaction processing server 108, database 150, a cloud and other sources of information to determine a driver for a request by the determination server 140. For example, the data module 906 may be configured to receive data and information required for: a position associated with a road relative to one or more roads based on a total number of one or more vehicles that travelled on the road and a speed of the one or more vehicles on the road; determining a priority level of the road based on whether a position associated with a priority level relative to one or more priority levels for the one or more roads matches the position associated with the road; determining a percentage of road length associated with the priority level relative to a total road length of the one or more roads, and determining the position associated with the priority level based on the percentage; determining whether a total length of the road is encompassed in a road length associated with the priority level; assigning a next lower priority level to the road when the total length of the road is not encompassed in the road length associated with the priority level; calculating, for each road of the one or more roads, a value associated with each road based on a total number of one or more vehicles that travelled on each road and a speed of the one or more vehicles on each road, and positioning each road of the one or more roads based on the value calculated for each road; determining whether a value associated with each of two or more roads fall within a same range of values, and combining a total road length of the two or more roads for the same range of values based on the determination; assigning a priority level to each of the one or more roads based on the value calculated for each road; determining the total number of the one or more vehicles that travelled on the road based on a total GPS ping count associated with the road; determining the speed of the one or more vehicles on the road based on a movement of a GPS ping associated with each of the one or more vehicles on the road and a total GPS ping count associated with the road; when determining a route from a first location to a second location, selecting one or more roads based on a priority level associated with each road for the route; and other similar processes from the requestor device 102, the provider device 104, transaction processing server 108, database 150, and/or other sources of information. The data module 906 may be further configured to send information relating to data retrieved in response to a request to the requestor device 102, the provider device 104, the transaction processing server 108, or other destinations where the information is required.

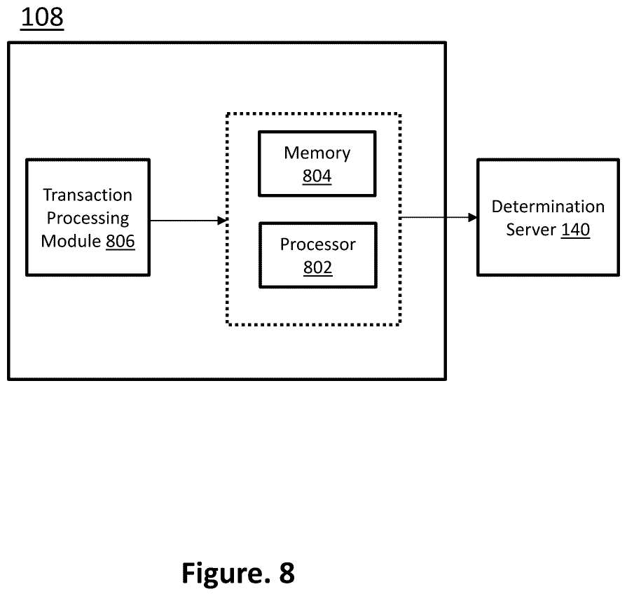

FIG. 8B depicts a general-purpose computer system 1500, upon which a combined transaction processing server 108 and determination server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 500 performed by the determination server 140 and facilitated by the transaction processing server 108 may be implemented using the computer system 1500. For example, the steps of the method 500 as performed by the determination server 140 may be implemented as one or more software application programs 1533 executable within the computer system 1500. In particular, the steps of the method 500 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the method 500 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and determination server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and determination server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (e.g., combined transaction processing and determination server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

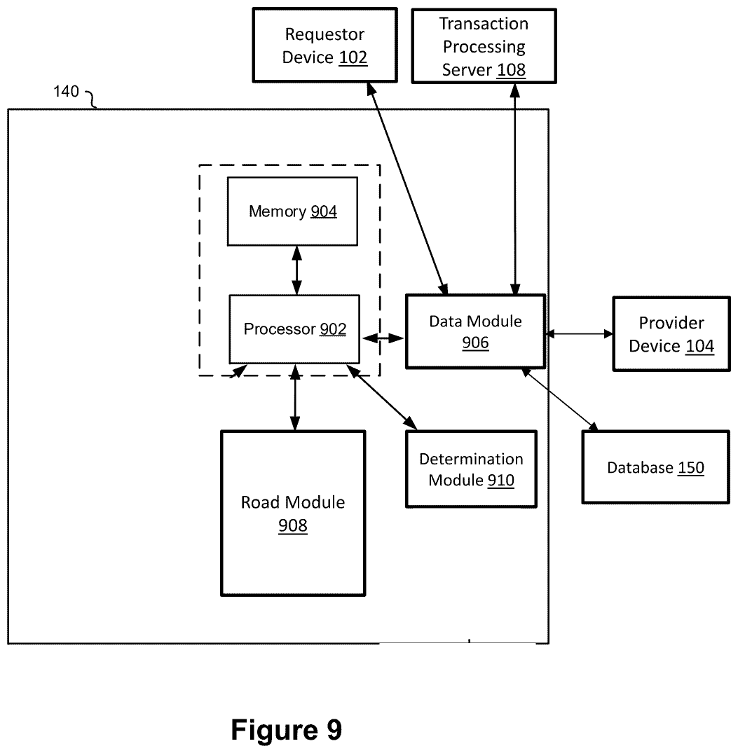

FIG. 10 shows an alternative implementation of combined transaction processing and determination server (i.e., the computer system 1500). In the alternative implementation, the combined transaction processing and determination server may be generally described as a physical device comprising at least one processor 1002 and at least one memory 904 including computer program codes. The at least one memory 1004 and the computer program codes are configured to, with the at least one processor 1002, cause the combined transaction processing and determination server to perform the operations described in the steps of the method 500. The combined transaction processing and determination server may also include a transaction processing module 806, a data module 906, an road module 908 and a determination module 910. The memory 1004 stores computer program code that the processor 1002 compiles to have each of the modules 806 to 910 performs their respective functions. The transaction processing module 806 performs the same functions as described for the same transaction processing module in FIG. 8. The data module 906, road module 908 and determination module 910 perform the same functions as described for the same corresponding modules in FIG. 9.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

What is claimed is:

1. A method for determining a priority level of a road, comprising:
determining, by a processor, a position associated with a road relative to one or more roads based on a total number of one or more vehicles that travelled on the road and a speed of the one or more vehicles on the road; and
determining, by the processor, a priority level of the road based on whether a position associated with a priority level relative to one or more priority levels for the one or more roads matches the position associated with the road.

2. The method of claim 1, wherein determining the priority level of the road further comprises determining a percentage of road length associated with the priority level relative to a total road length of the one or more roads, and determining the position associated with the priority level based on the percentage.

3. The method of claim 1, wherein determining the priority level of the road further comprises determining whether a total length of the road is encompassed in a road length associated with the priority level.

4. The method of claim 3, further comprising assigning a next lower priority level to the road when the total length of the road is not encompassed in the road length associated with the priority level.

5. The method of claim 1, wherein determining the position associated with the road further comprises calculating, for each road of the one or more roads, a value associated with each road based on a total number of one or more vehicles that travelled on each road and a speed of the one or more vehicles on each road, and positioning each road of the one or more roads based on the value calculated for each road.

6. The method of claim 5, further comprising determining whether a value associated with each of two or more roads fall within a same range of values, and combining a total road length of the two or more roads for the same range of values based on the determination.

7. The method of claim 5, further comprising assigning a priority level to each of the one or more roads based on the value calculated for each road.

8. The method of claim 1, further comprising determining the total number of the one or more vehicles that travelled on the road based on a total global positioning system (GPS) ping count associated with the road.

9. A system for determining a priority level of a road, comprising:
at least one processor; and at least one memory including computer program code; the at least one memory and the computer program code configured to, with the at least one processor, cause the system at least to:
determine a position associated with a road relative to one or more roads based on a total number of one or more vehicles that travelled on the road and a speed of the one or more vehicles on the road; and
determine a priority level of the road based on whether a position associated with a priority level relative to one or more priority levels for the one or more roads matches the position associated with the road.

10. The system of claim 9, wherein determining the priority level of the road further comprises determining a percentage of road length associated with the priority level relative to a total road length of the one or more roads, and determining the position associated with the priority level based on the percentage.

11. The system of claim 9, wherein determining the priority level of the road further comprises determining whether a total length of the road is encompassed in a road length associated with the priority level.

12. The system of claim 11, further configured to assign a next lower priority level to the road when the total length of the road is not encompassed in the road length associated with the priority level.

13. The system of claim 9, wherein determining the position associated with the road further comprises calculating, for each road of the one or more roads, a value associated with each road based on a total number of one or more vehicles that travelled on each road and a speed of the one or more vehicles on each road, and positioning each road of the road network based on the value calculated for each road.

14. The system of claim 13, further configured to determine whether a value associated with each of two or more roads fall within a same range of values, and combine a total road length of the two or more roads for the same range of values based on the determination.

15. The system of claim 13, further configured to assign a priority level to each of the one or more roads based on the value calculated for each road.

16. The system of claim 9, further configured to determine the total number of vehicles that travelled on the road based on a total global positioning system (GPS) ping count associated with the road.
